(19) United States
(12) Patent Application Publication
(10) Pub. No.: US 2008/0190303 A1
(43) Pub. Date: Aug. 14, 2008

(54) Method and Device for Minimizing Giveaway

(76) Inventors: Gunther Hiederer, Kempten (DE); Stefan Stadtmuller, Sulzberg (DE)

Correspondence Address: FOLEY & LARDNER LLP, 777 EAST WISCONSIN AVENUE, MILWAUKEE, WI, 53202-5306, US

(21) Appl. No.: 11/660,422

(22) PCT Filed: Aug. 17, 2005
(86) PCT No.: PCT/EP05/54050

§ 371 Date: Oct. 1, 2007

(30) Foreign Application Priority Data
Aug. 17, 2004 (DE) 102004 039 892.5
Dec. 6, 2004 (DE) 10 2004 058 873.2

(51) Int. Cl. A23N 15/00; B26D 7/30; B26D 5/00; B26D 1/00

(52) U.S. Cl. 99/537; 83/77; 83/74; 83/13

(57) ABSTRACT

The present invention relates to a device for slicing a food bar, which has a certain mass per unit length variation over its length, into food portions which, for example, each consist of N food slices and are to have a defined preset weight m_{M}, having a blade and a support device on which the food bar lies and can be advanced in the direction of the blade, the size of this advance determining the thickness of the food slice. In addition, the invention relates to a method which has means which calculates a prediction of the mass per unit length variation of the still unsliced food bar and, based thereon, adjusts the number N and/or the thickness Dₛ of the food slices of the portion being sliced or the next portion to be sliced such that the actual weight approximates to the preset weight as closely as possible.

The present invention relates to a device for slicing a food bar, which has a certain mass per unit length variation over its length, into food portions which each consist of N food slices and are to have a specified preset weight m_{M}, having a blade and a support device on which the food bar lies and can be advanced in the direction of the blade, the size of this advance determining the thickness of the food slice. The invention also relates to a method for maintaining as accurately as possible the preset weight of a food portion which consists of N food slices cut from a food bar which has a certain mass per unit length variation over its length.

Food products are nowadays often offered in portions consisting of several food slices. The food slices are cut, for example, from a food bar and then or simultaneously configured into portions. The number and thickness of the slices must be chosen such that the product contained in a package at least corresponds to the nominal weight given on the package. In order to ensure this, a preset weight is given by the food manufacturers, which is above the nominal weight, so that the packages usually contain more product than is shown on the packaging, thus ensuring that the weight does not fall below the nominal weight. The cost for this ‘giveaway’ cannot be passed on by the food manufacturers to the consumers, as a result of which there is a desire on the part of the food manufacturers for the preset weight of a sliced food package to lie as little as possible above the nominal weight given on the package, which is only possible, however, with a device which maintains the required preset weight within very narrow tolerances.

The weight of a portion can be controlled by the machine by means of the cut slice thickness and/or the number of slices. Since feedback on the weight of the respective sliced portion is available only after a certain time, the regulation which in the past was carried out with PID controllers proved to be problematic, in particular due to the typical settling times, in particular if very small deviations of the respective portions from the preset weight were required.

It is therefore an object of the present invention to provide a device and a method for the most accurate possible maintenance of the preset weight of a food portion.

This object is achieved with a device for slicing a food bar, which has a certain mass per unit length variation over its length, into food portions which each consist of N food slices and are to have a defined preset weight m_{M}, having a blade and a support device on which the food bar lies and can be advanced in the direction of the blade, wherein the size of this advance determines the thickness of the food slice and which has means which, based on historical information, calculates a prediction of the mass per unit length variation of the still unsliced food bar and on the basis thereof, sets the number N and/or the thickness Dₛ of the food slices of the portion being sliced or the next portion to be sliced such that the actual weight approximates to the preset weight as closely as possible.

It was entirely surprising to a person skilled in the art and not to be expected that the desired preset weight of a package could be very accurately maintained with the device according to the invention. Since the regulation is based on a mathematical prediction model, the settlement times that are typical of a PID controller do not arise. Product anomalies such as wedge cuts or faulty measurements are detected by the device according to the invention and compensated for substantially better than was the case with prior art devices.

A food bar within the meaning of the invention is any product commonly known by persons skilled in the art which is cut into slices. Preferably, a food bar consists of cheese, sausage or ham.

These food bars are cut into slices and configured into portions. The weight of each portion and the associated cut length are placed in a store. These data are taken into account when determining the advance.

According to the invention, the device has means which calculates a prediction about the mass per unit length variation of the still unsliced food bar. Mass per unit length within the meaning of the invention is the local cross-sectional area A of the food bar multiplied by the local density. If the mass per unit length over the course of the product, that is its longitudinal extent, is known then the slice thickness of each portion can be exactly calculated since:

m_{M}=δ×A×D₁

D₁ represents the total actual product length belonging to a portion, m_{M} represents the associated measured weight. Therefore, for the next preset product length to be cut off

$$Ds = \frac{{m}_{M}}{δ \times A} .$$

The resulting slice thickness is then

$$d = \frac{{D}_{s}}{N} ,$$

where N is the number of slices per package, or the resulting number of slices is

$$N = \frac{{D}_{s}}{d} ,$$

or any desired combination of slice thickness and number of slices.

Over the course of the product, from the measured package weight and the associated product length cut off, for each package the associated mass per unit length δ×A is calculated and a prediction is made into the future regarding a suitable prediction amount.

Preferably, the prediction of the mass per unit length is based on two factors:

the current mass per unit length variation of the product, which is extrapolated and

the historical mass per unit length variation, which is stored in relation to the product.

A prediction within the meaning of the invention is therefore not based on a measurement of the food bar before or during the slicing, as known from the prior art.

In a preferred embodiment of the present invention, using a suitable mathematical method, preferably a mathematical regression model, based on the weight measurements already present as feedback, future mass per unit length values are extrapolated, for example, by means of a polynomial extrapolation. This is preferably designed such that the newest feedback is fed more strongly into the prediction than older feedback concerning the product currently being sliced.

Once a product has been fully sliced, preferably the centre of mass is determined, preferably using numerical integration, in order to identify clearly products with continuously falling or increasing mass per unit length. This is particularly important with products that do not have an approximately constant cross-section. Thereafter, both the mean mass per unit length variation and the variation of the standard deviation over the product length is found and preferably stored in a control system assigned to the means. The standard deviation is an important criterion for assessment of the constancy of the mass per unit length variation of a product.

Preferably both the extrapolation of the current mass per unit length variation and the historical mass per unit length variation are used for the prediction of the product density. The smaller the standard deviation of the historical mass per unit length variation, that is, the more similar the individual products of this product type are with regard to their mass per unit length variation, the more strongly the prediction is formed on the basis of the historical mass per unit length variation, and conversely where the standard deviation of the historical mass per unit length variation is high, the prediction of product density is more strongly based on the extrapolation of the current mass per unit length variation.

Preferably, a food bar is subdivided into three sections: product beginning, product body and product end. The product could also be subdivided into more than three sections, which is advantageous in particular with products such as ham, whereby the cross-section varies greatly over the length. For this purpose, the regression models implemented in the system are preferably chosen such that they correspond as well as possible to the actual course. This is preferably assessed using the least mean squares method.

For each product section, a mathematical regression model is stored whose coefficients are determined both for the food bar currently being sliced as well as for all the previously sliced food bars of the respective food. The regression model takes account of the historical measured values of the previously sliced food bars of the same type. This makes it possible both to make a prediction available on the mass per unit length without any weight feedback, as well as an improved prediction quality once the first weight feedback information is made available, since then the approximate current mass per unit length variation is already known. The prediction of mass per unit length without weight feedback is important, in particular, for the product beginning, since here, in principle, no feedback is yet available. Furthermore, the mass per unit length without any weight feedback is significant as a substitute value in the event of obviously erroneous measurements. The choice of the most appropriate regression model is determined using the least mean squares method.

Based on the product properties, the extrapolation preferably takes account of both long-term and short-term trends. This is preferably carried out using a long-term approximation of low polynomial order and one or more simultaneously overlaid interpolations of high polynomial order over partial sections of corresponding length. For each of these summands, the corresponding historical course can be included for the extrapolation, depending on the standard deviation as determined.

In another preferred embodiment of the present invention, the prediction is carried out using a component model which preferably has the following form:

y(t)=g(t)+u(t)×cos(p)

This consists of a smooth, non-fluctuating long-term component g(t), also known as the trend. This component is determined by means of the least squares method from both the current and the historical course and is formed over the course of the product body, preferably without the beginning and the end, by a straight line equation. This corresponds to a low-pass filtration of the course. At the beginning and end of the product, a relatively high order polynomial is used to determine the smooth component.

The remaining component u(t) is determined by a multiple exponential moving average with a short-term trend component. This algorithm has as its sole parameter the weighting of the historical depth of the data, that is, how many data from the past are included in the current prediction. This parameter is continuously monitored during the slicing process and is constantly optimised using the least squares method. This corresponds to a high-pass filtration of the course.

Depending on the number of dead packages, that is, the number of packages which are situated between the actual slicing of the package and the weighing of this package, there is always a phase offset in each prediction between the prediction and the actual feedback. It has also been found, however, that the variations about the smooth component g(t) occur in at least similarly spaced intervals. These are measured during the slicing and, in the case of severely varying products or products with a small number of slices, can then be taken account of ahead of phase.

Preferably, with this method also, the food bar is subdivided into three sections, namely the product beginning, the actual product body and the product end. This is necessary because in each of these sections, a mass per unit length must be predicted separately.

For the product beginning, the following characteristic values apply: starting diameter of the product beginning, either absolute or relative to the calibre and length of the product beginning. These data should preferably be available during the first slicing of this product. During further slicings, these data are calculated retrospectively from the slicing result and also stored in the product history. For the prediction of the course of the smooth component of the product beginning, a polynomial interpolation between the starting diameter, the expected end diameter and the length of the product beginning is carried out.

The prediction of the mass per unit length variation at the product end takes place just as the prediction does at the product beginning, only here it is also adaptively recognised from when the transition between product body and product end takes place. This takes place preferably via the evaluation of the mean fluctuation breadth over the course of the product. If the product has progressed far enough that it could be starting into the product end region and if the measured value is also above twice the standard deviation, then it is assumed that the beginning of the product end has been reached.

Then the prediction regulation for the smooth component is used, just as it is at the product beginning.

For the product body, a simple straight line equation is preferably assumed for the smooth component, since on average the product body is constantly decreasing, constantly increasing or constant. The parameters of the straight line equation are continuously determined using the least squares method. Preferably, historical data are additionally brought in, particularly at the product beginning. Further parallel straight lines with single and double standard deviation are laid round this straight line. According to the statistical normal distribution, 68.3% of the values lie in the range of ± s and 95.5% of the values lie in the range of ±2×s. Overshooting or undershooting double the standard deviation is therefore very rare and may be regarded as a unique event not belonging to the actual course of the product (e.g. a wedge-shaped slice, a faulty measurement). Such data are therefore not used for further prediction, but in their place, the mean value from the smooth component is used ± the single standard deviation. On undershooting or overshooting the actual standard deviation, PID controllers produce an error. Since these have no statistical data on the food bars, they assume that the course then continues in this direction, which however is unlikely in view of the standard deviation. Preferably, at a site of this type, a constant mass per unit length or even a reversal of the trend is predicted.

The remaining component is determined, as described above, via simple exponential moving averages and is continuously optimised via the method of least squares.

Using the algorithm of the component model in conjunction with the prediction by multiple exponential moving averages or by means of an adaptive filter, results are achieved that are immediately at least equal to the PI controller. Furthermore, adaptive parameter setting can be achieved by minimising the error squares over the depth of the looking back time which, in the case of a PI controller is not immediately possible, since with a PI controller, there is always a danger of overshoot. This is substantially reduced with the device according to the invention.

In particular, the storage and availability of statistical data is advantageous with the device according to the invention, since beyond a certain package weight, a further increase or a further fall is simply very unlikely. Without statistical data, however, this cannot be recognised and therefore leads to packages with erroneous slicing weights, since the manipulated variable continues in the respective direction.

As mentioned above, for adjusting an actual weight that approaches a preset weight as closely as possible, both the number of slices and the slice thickness can be varied. A person skilled in the art would realise, however, that this can only be carried out within certain limits. Preferably, the upper and/or lower limit of thickness of a slice is therefore passed to the control system and/or the minimum and/or maximum number of slices per portion is given. Particularly preferably, the number of slices per portion is given and the slice thickness determined accordingly.

Preferably, for a computer program which is stored in a control system of the device according to the invention, the number of food slices is kept constant for one product type.

For many products, the weight of the portions varies with relatively low frequencies about the mean package weight. For these products and for a comparatively large number, preferably 2-3, of portions between the slicing and determination of the weight of this portion, these circumstances are used adaptively in that the remaining component u(t) is added in phase-shifted manner to the trend component g(t). The phase offset is visible from the previously cut product. The optimisation of the individual variables takes place independently of each other in quantity and phase; that is, u(t) for the amplitude and cos(p) for the phase. This regulation can be carried out without an adaptive filter.

For the averaged difference in the measured products from the stored mathematical model, there is noise at every product point, which gives the mean deviation of a product from the mathematical model. This noise provides a means for predicting the mass per unit length variation preferably for the purpose of predicting the actual product course with regard to the mass per unit length, independently of random product anomalies. Furthermore, the product noise is a measure for validating the weight measurement. Preferably, the means is an adaptive digital filter, wherein the noise is an input variable of the digital filter.

Preferably, the means for predicting the mass per unit length variation is adaptive, particularly preferably an adaptive digital filter. From the stored mathematical model, the known measuring data of the weight and the cut product length and the product noise, the adaptive digital filter calculates a prediction concerning the mass per unit length variation. Based on the newly estimated mass per unit length, as mentioned above, the slice thickness and/or the number of slices is determined.

For this purpose, the adaptive digital filter used separates the noise, which is known from the prior product history, from the actual course of the product and extrapolates this development into the future, depending on the dead portion count.

All the data from the categories of product classification, product regression and product noise belonging to one product are held in a memory structure belonging to a control system of the device according to the invention and, after each completed cut portion, brought up to date. By this means it is ensured that, given a creeping product change, all the important statistics are up to date.

For determination of the mass per unit length, preferably both the measured package weight and the product length cut off in total over all the slices per package is taken into account. In contrast to the package weight, the product length cut off can only be measured indirectly via the advance position change. Since, however, the product is compressed or decompressed, this value does not have to correspond exactly to the length cut off. From this, under certain circumstances, a lasting mass per unit length measuring error results which can lead, over many packages, to permanently overweight or underweight packages. Preferably, the device according to the invention therefore has a further adaptive digital filter which takes account only of the preset/actual weight ratio, which then compensates for this error accordingly.

It is a further object of the present invention to provide a method for the most accurate possible maintenance of the preset weight of a food portion, wherein the number of dummy cuts between the slicing of two portions during the slicing of a food bar is reduced at least once.

Preferably, the total thickness of the portion to be cut off is calculated based on historical information and the desired preset weight. This total thickness is then divided into n slices according to the desired slice thickness and/or the desired number of slices n and a corresponding portion is cut off the food bar. Preferably, after the slicing of this portion, a number of dummy cuts is made until the actual weight of this portion has been determined. The estimated (calculated) weight is compared with the actual weight. Based on this comparison, the rule is then possibly adapted. Thereafter, the dummy cuts are preferably reduced to the size necessary for the normal slicing process.

It is a further object of the present invention to provide a method for the most accurate possible maintenance of the preset weight m_{M} of a food portion consisting of N food slices, cut off a food bar which has a certain mass per unit length variation over its length, wherein the mass per unit length variation is predicted and, based on the prediction, the number N and/or the thickness Dₛ of the food slices of the portion being sliced or the next portion to be sliced is adjusted so that the actual weight approximates to the preset weight as closely as possible.

All the disclosures made above apply similarly for the method according to the invention.

Preferably, in the method according to the invention, the number of slices per package is kept constant and only the advance and therefore the slice thickness is optimised.

In another preferred embodiment of the present invention, the number of slices cut off is optimised according to the above equation. Particularly preferably, this is carried out by controlling the time point of a dummy cut, during which no product is cut off and the prepared item is transported out of the cutting area.

With regard to the prediction of mass per unit length variation, reference is made to the above.

A person skilled in the art recognises that the device according to the invention is usable on machines or in methods wherein n lines are sliced simultaneously or offset, wherein n is equal to or greater than 2. The advance and/or the number of slices are then controlled for them all or individually.

With the device according to the invention and with the method according to the invention, the historical data on the mass per unit length variation can also be used in order to distribute an overlapped portion optimally in a package. On the basis of the historical data, historical geometrical data on the product to be sliced are also available for a rectangular product, for example, its width and height and, for a round product, for example, its diameter. On the basis of these data and, for example, a predetermined number of slices or a predetermined slice thickness and the number of slices resulting therefrom, a computer calculates the desired overlap such that, on the one hand, a predetermined package length L is preferably utilised as completely as possible and, on the other hand, the overlapping is as even as possible.

In the case of a rectangular product wherein the height h of the product varies along the length of the food bar, the following formula applies to the overlapping ü\ddot{}for n slices:

ü=(L−h)/(n−1)

### EXAMPLES

A package with the net weight of 100 g is classified as a good package if it fulfils at least the following criteria:
98% of the packages lie within the range of ±4.5% of the nominal weight
2% of the packages lie within the range of ±9% of the nominal weight
the mean value of the weight of all the cut packages is greater than or equal to the nominal weight.

It is the aim to optimise the algorithm so that both as many good packages as possible are achieved, and the mean weight of the good packages lies as little as possible above the nominal weight. For this purpose it is favourable if the fluctuation width is as small as possible, since this can then be applied adaptively to the nominal weight (for example, fluctuation width of the package weight ±0.3%, so that the addition to the package weight is 0.3%).

### Example 1

The values were determined by simulation across a plurality of data sets.

| | | | Mean percentage |
|---|---|---|---|
| Prediction | Good | Mean absolute | deviation from |
| method | packages | errors per package | nominal weight |
| PI controller* | 75% | 2.3% | +0.22% |
| Prediction model | 80% | 1.9% | +0.12% |

*PI controller under optimum conditions, that is, completely steady at the start of the simulation. The P and I components were set by experiment to minimum errors per product. The values currently achieved in practice would in any event have to be worse.

### Example 2

The values were determined by simulation across a plurality of data sets.

| | | Mean absolute | Mean percentage |
|---|---|---|---|
| Prediction | | errors | deviation from |
| method | Good packages | per package | nominal weight |
| PI controller | 65% | 4.5% | −4.3% |
| Prediction model | 70% | 4.0% | −0.9% |

It has been found that the prediction model achieves a better result and, evidently, the significantly better values for the mean percentage deviation from the nominal weight. The additive application to the nominal weight and the resultant effective cut package weight were thereby significantly reduced.

1.-13. (canceled)

14. A device for slicing a food bar, comprising:
a blade for slicing a food bar into at least one food portion, the food portion including a plurality of food slices and being associated with a specified preset weight;
a support device configured to support the food bar and advance the food bar in the direction of the blade, the advance of the food bar determining the thickness of each of the food slices; and
means which calculate a prediction of the mass per unit length variation of the unsliced portion of the food bar.

15. A device according to claim 1, wherein the means utilizes a mathematical regression model.

16. A device according to claim 1, wherein the prediction is based on at least one of an extrapolation of the current mass per unit length variation of the food bar being sliced and a historical mass per unit length variation stored for a product type of the food bar.

17. A device according to claim 1, wherein the means is adaptive.

18. A device according to claim 1, wherein the means is an adaptive digital filter.

19. A device according to claim 1, further comprising:
second means which carries out an advance measuring error correction.

20. A device according to claim 19, wherein the second means is an adaptive digital filter.

21. A method for accurate maintenance of a preset weight of a food portion, the food portion including a number of food slices sliced from a food bar which has a mass per unit length variation over its length, the method comprising:
predicting the mass per unit length variation for the unsliced portion of a food bar; and
based on the prediction, adjusting at least one of the number of food slices and the thickness of food slices for a food portion being sliced.

22. A method according to claim 21, further comprising:
adjusting an advance of the food bar.

23. A method according to claim 21, further comprising:
adjusting the time point of a dummy cut.

24. A method according to claim 21, wherein the mass per unit length variation is calculated on the basis of the current mass per unit length variation of the food bar currently being sliced and a historical mass per unit length variation stored for a product type of the food bar.

25. A method according to claim 21, wherein the prediction is calculated on the basis of at least one of a mathematical regression model and a digital filter.

26. A method according to claim 25, further comprising:
dividing the food bar into a plurality of sections;
wherein the regression model is adapted to the respective sections.
